(19) United States
(12) Patent Application Publication
(10) Pub. No.: US 2010/0018618 A1
(43) Pub. Date: Jan. 28, 2010

(54) TIRE WITH TREAD HAVING A TWO-PLY TREAD CAP LAYER

(76) Inventors: Brandy Elizabeth Moorhead, Uniontown, OH (US); Jennifer Lyn Ryba, Wadsworth, OH (US); Matthias Bode, Gruendau (DE); Colleen Anne Nowacki, Uniontown, OH (US); Daniel Christian Shavers, Canton, OH (US); David Ray Hubbell, Hartville, OH (US); Michael Howard Curtis, Stow, OH (US); Justin Barker, Stow, OH (US); Marc Christopher Nowacki, Uniontown, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 12/178,719

(22) Filed: Jul. 24, 2008

(51) Int. Cl. B60C 1/00; B60C 11/24

(52) U.S. Cl. 152/209.5; 152/209.1

(57) ABSTRACT

The invention relates to a tire with a tread of a cap/base construction comprised of a two-ply (dual layered) tread cap rubber layer comprised of a combination of an outer tread cap layer and an inner tread cap layer together with an underlying tread base rubber layer which underlies the two-ply tread cap layer. The tread cap layer is of a lug and groove configuration with at least a portion of the grooves extending through the outer tread cap layer into the inner tread cap layer without extending to the tread base rubber layer. The outer tread cap rubber layer is comprised of a carbon black-rich rubber composition to promote dry traction for the tread running surface. The inner tread cap layer is comprised of a softer silica-rich rubber composition to promote wet traction for tread running surface as the outer tread cap layer wears away to expose the softer inner tread cap layer.

### FIELD OF THE INVENTION

The invention relates to a tire with a tread of a cap/base construction comprised of a two-ply (dual layered) tread cap rubber layer comprised of a combination of an outer tread cap layer and an inner tread cap layer together with an underlying tread base rubber layer which underlies the two-ply tread cap layer. The tread cap layer is of a lug and groove configuration with at least a portion of the grooves extending through the outer tread cap layer into the inner tread cap layer without extending to the tread base rubber layer. The outer tread cap rubber layer is comprised of a carbon black-rich rubber composition to promote dry traction for the tread running surface. The inner tread cap layer is comprised of a softer silica-rich rubber composition to promote wet traction for tread running surface as the outer tread cap layer wears away to expose the softer inner tread cap layer.

### BACKGROUND FOR THE INVENTION

For vehicular tires intended for high performance, dry traction for its tread running surface is often desirable. Such dry traction may be promoted, for example, by a combination of dry traction induced rubber composition and physically induced dry traction by an associated stiffness of the tread lugs of the tread cap layer.

In practice, as the height of the tread lugs decreases as the tread wears away (as the tread depth and height of the tread lugs decreases), it is envisioned that a geometrically induced increase in tread lug stiffness naturally occurs by the geometric reduction in tread lug height (resultant shorter tread lugs) with an associated auto-promotion (automatic promotion) of a stiffer “bite” of the tread lugs over the ground and an associated increase in dry traction of the tread over the ground (traction of the tread running surface over dry surfaces).

Relying upon this phenomenon of geometrically induced auto-promotion of stiffer “bite” of the tread lugs as they become shorter by wearing away, with an associated increase in dry traction (as a result of increased tread lug stiffness) of the tread running surface, it was envisioned that an opportunity of providing a rubber composition induced increase, or enhancement, of wet traction for the tread running surface might be presented at an expense of such aforesaid geometrically induced dry traction by providing an inner tread cap rubber layer of reduced stiffness.

In this manner then, it was envisioned that, as the outer tire tread wears away, an advantage of compositional wet traction enhancement may be promoted without significant sacrifice, or reduction, in dry traction.

Accordingly, for this invention, a tire tread is provided with lug and groove configured a dual layered tread cap layer in which the outer tread cap rubber layer is provided with a rubber composition to promote dry traction and the underlying inner tread cap rubber layer is provided with a rubber composition to promote wet traction for the tire tread as it becomes exposed as the outer tread wears away, and thereby a part of the tread running surface.

In an embodiment of the invention, at least a portion of the tread grooves extend radially inward through the outer cap rubber layer and into the underlying inner tread cap rubber layer.

In an embodiment of the invention, as the outer tread cap rubber layer, and its associated tread lugs with their running surfaces, wears away during the service of the tire over time, the underlying inner tread cap rubber layer, which extends radially outwardly into a portion of the lugs and into the grooves of the outer tread cap rubber layer, becomes exposed and thereby becomes a new portion of the running surface of the tread prior to the tread being sufficiently worn to warrant removing the tire from service. In this manner, then, the inner tread cap rubber layer presents a new running surface for the tread after a sufficient amount of the outer tread cap rubber layer wears away.

In one embodiment then, such tire is provided wherein at least a portion of said underlying inner tread cap rubber layer is positioned within at least one of said tread lugs of said outer tread cap rubber layer in a manner to become a running surface of the tire upon at least a portion of said lug of said outer tread cap layer wearing away (e.g. as the tire is run in service) to expose said tread cap inner rubber layer.

Historically, various dual layered tire treads have heretofore been proposed which are composed of a cap/base construction in which the outer tread cap rubber layer contains a running surface for the tire and the underlying tread base rubber layer provides, in a sense, a cushion for the tread cap layer, such as for example U.S. Pat. No. 6,959,743 or of a dual tread base layer configuration, such as for example U.S. Pat. No. 6,095,217 as well as a cap/base construction in which the base layer extends into lugs of the tread and into its tread cap layer such as for example U.S. Pat. No. 6,336,486.

In the description of this invention, the terms “rubber” and “elastomer” may be used interchangeably unless otherwise indicated. The terms “rubber composition”, “compounded rubber” and “rubber compound”, may be used interchangeably to refer to “rubber which has been blended or mixed with various ingredients” and the term “compound” relates to a “rubber composition” unless otherwise indicated. Such terms are well known to those having skill in the rubber mixing or rubber compounding art.

In the description of this invention, the term “phr” refers to parts of a respective material per 100 parts by weight of rubber, or elastomer. The terms “cure” and “vulcanize” may be used interchangeably unless otherwise indicated. The term “Tg”, if used, means the middle point glass transition temperature of an elastomer determined by DSC (differential scanning calorimeter) at a heating rate of 10° C. per minute as would be understood by those having skill in such art.

### SUMMARY AND PRACTICE OF THE INVENTION

In accordance with this invention, a tire is provided having a rubber tread of a cap/base construction comprised of a tread cap rubber layer and an underlying tread base rubber layer (positioned radially inward of and underlying said outer tread cap layer);

wherein said tread cap rubber layer is comprised of an outer tread cap rubber layer and an underlying inner tread cap rubber layer (underlying said outer tread cap rubber layer);

wherein said tread cap rubber layer is composed of a lug and groove configuration with raised lugs having tread running surfaces (said running surfaces intended to be ground-contacting) and grooves positioned between said lugs, and wherein at least a portion of said grooves extend through said outer tread cap rubber layer and into said tread cap inner rubber layer, exclusive of said underlying tread base rubber layer.

In one embodiment, the rubber composition of said tread outer cap rubber layer has a dynamic storage modulus G′ (at 100° C., 1% strain and 1 Hertz) in a range of from about 3,000 to about 7,000, alternately from about 4,000 to about 6,000, KPa and the rubber composition of said tread inner cap rubber layer has a dynamic storage modulus G′ (at 100° C., 1% strain and 1 Hertz) in a range of from about 1,500 to about 4,500, alternately from about 2,500 to about 4,000, KPa;

wherein said storage modulus G′ of said rubber composition of said tread cap inner rubber layer is at least 1,000 KPa, alternately at least 1,500 KPa, less than said storage modulus G′ of said rubber composition of said outer tread cap rubber layer.

In one embodiment, the Shore A (100° C.) hardness values of the sulfur cured rubber compositions of said tread outer cap rubber layer and said tread inner cap rubber layer are in a range of from about 60 to about 85 wherein said Shore A hardness of said rubber composition of said tread cap outer rubber layer is at least about 5 Shore A hardness units greater than, and preferably within about 15, alternately within about 10, Shore A hardness units of, the Shore A hardness of the rubber composition said inner tread cap rubber layer.

In one embodiment, the sulfur cured carbon black-rich rubber composition of said outer tread cap rubber layer is comprised of, based upon parts by weight per 100 parts by weight rubber (phr):

(A) 100 phr of at least one conjugated diene-based elastomer;

(B) from about 45 to about 110 phr of rubber reinforcing filler comprised of:
(1) from about 40 to about 100 phr of rubber reinforcing carbon black,
(2) from about 5 to about 30 phr of synthetic amorphous silica (for example, precipitated silica); and

(C) silica coupler having a moiety reactive with hydroxyl groups (e.g. silanol groups) on said silica and another different moiety interactive with said diene-based elastomer(s), and

said silica-rich rubber composition of said inner tread cap rubber layer is comprised of, based upon parts by weight per 100 parts by weight rubber (phr):

(D) 100 phr of at least one conjugated diene-based elastomer;

(E) from about 60 to about 110, alternately from about 75 to about 110, phr of rubber reinforcing filler comprised of:
(1) from about 50 to about 100, alternately from about 50 to about 75, phr of synthetic amorphous silica (for example, precipitated silica), and
   (2) from about 10 to about 45, alternately from about 25 to about 45, phr of rubber reinforcing carbon black;

wherein the rubber composition of said inner tread cap rubber layer contains at least 20 phr more of said precipitated silica reinforcement than said rubber composition of said outer tread cap rubber layer, and

(F) silica coupler having a moiety reactive with hydroxyl groups (e.g. silanol groups) on said silica and another different moiety interactive with said diene-based elastomer(s).

The combination of the grooved tread cap rubber layer and associated underlying inner tread cap rubber layer is considered herein to be synergistic in a sense that, as the outer tread cap layer wears away during the service of the tire, with an associated geometrical stiffening of the included tread grooves which extend through the outer tread cap layer into the inner tread cap layer, the underlying inner tread cap rubber layer becomes a portion of the running surface of the tread in a manner that the running surface of the tire can present enhanced traction properties of the tire running surface to the road.

Accordingly, upon wearing away of the outer tread cap rubber layer during the service of the tire, with an associated geometrical stiffening of the tread lugs as they become shorter, to expose at least a portion of the inner tread cap rubber layer as a running surface of the tread, the running surface of the tread thereby presents a combination of dry and enhanced wet traction properties of the tire running surface to the road. In this manner, as the tread wears away, an enhanced wet traction for the running surface of the tread is promoted, in part by an inclusion of an increased precipitated silica content of the rubber composition of the inner tread cap rubber layer, while substantially maintaining the dry traction of the running surface of the tread (the bite of the tread running surface presented to the ground) by the geometrically increased stiffness of the tread lugs as they become shorter by being worn down.

In one embodiment, said inner tread cap rubber layer extends radially outward into and within at least a portion of at least one of said tread lugs such that the inner tread cap layer extends radially outward beyond a treadwear indicator within an associated tread groove. Use of treadwear indicators in various tires to visually indicate the end of the intended service life of the tire tread is well known to those having skill in such art. Accordingly, it is preferred that the inner tread cap rubber layer within the tread lug extends radially outward beyond the tread wear indicator in a manner that the inner tread cap rubber layer becomes exposed to and thereby a part of the tire tread's running surface as outer tread cap rubber layer wears away.

The precipitated silica is normally used in combination with a coupling agent having a moiety reactive with hydroxyl groups contained on the surface of the silica (e.g. silanol groups) and another moiety interactive with said diene-based elastomers.

A coupling agent for such silica may, for example, be a bis(3-trialkoxysilylalkyl) polysulfide which contains an average of from 2 to 4, alternately an average of from 2 to about 2.6 or an average of from about 3.4 to about 3.8, connecting sulfur atoms in its polysulfidic bridge. Representative of such coupling agent is for example, bis(3-triethoxysilylpropyl) polysulfide as being, for example, comprised of a bis(3-triethoxysilylpropyl) tetrasulfide, namely with the polysulfidic bridge comprised of an average of from about 3.2 to about 3.8 connecting sulfur atoms or a bis(3-triethoxysilylpropyl) disulfide with the polysulfidic bridge comprised of an average of from about 2.1 to about 2.6 connecting sulfur atoms.

Alternately, such coupling agent may be an organomercaptosilane (e.g. an alkoxyorganomercaptosilane), and particularly an alkoxyorganomercaptosilane having its mercapto function reversibly capped. Various of such alkoxyorganomercaptosilane coupling agents are well known to those having skill in such art.

In practice, the synthetic amorphous silica may be selected from aggregates of precipitated silica, which is intended to include precipitated aluminosilicates as a co-precipitated silica and aluminum.

Such precipitated silica is, in general, well known to those having skill in such art. The precipitated silica aggregates may be prepared, for example, by an acidification of a soluble silicate, e.g., sodium silicate, in the presence of a suitable electrolyte and may include co-precipitated silica and a minor amount of aluminum.

Such silicas might have a BET surface area, as measured using nitrogen gas, such as, for example, in a range of about 40 to about 600, and more usually in a range of about 50 to about 300 square meters per gram. The BET method of measuring surface area is described in the Journal of the American Chemical Society, Volume 60 (1938).

The silica might also have a dibutylphthalate (DBP) absorption value in a range of, for example, about 50 to about 400 cm³/100 g, alternately from about 100 to about 300 cm³/100 g.

Various commercially available precipitated silicas may be considered for use in this invention such as, only for example herein, and without limitation, silicas from PPG Industries under the Hi-Sil trademark with designations Hi-Sil 210, Hi-Sil 243, etc; silicas from Rhodia as, for example, Zeosil 1165 MP and Zeosil 165GR, silicas from J. M. Huber Corporation as, for example, Zeopol 8745 and Zeopol 8715, silicas from Degussa AG with, for example, designations VN2, VN3 and Ultrasil 7005 as well as other grades of precipitated silica.

Various rubber reinforcing carbon blacks might be used for the tread rubber compositions. Representative of various rubber reinforcing blacks may be referred to by their ASTM designations such as for example, although not intended to be limiting, N110, N121 and N234. Other rubber reinforcing carbon blacks may found, for example, in The Vanderbilt Rubber Handbook (1978), Page 417.

Representative of various diene-based elastomers for said tread cap rubber, said tread transition rubber layer and said optional base layer may include, for example, styrene-butadiene copolymers (prepared, for example, by organic solvent solution polymerization or by aqueous emulsion polymerization), isoprene/butadiene copolymers, styrene/isoprene/butadiene terpolymers and tin coupled organic solution polymerization prepared styrene/butadiene copolymers, c is 1,4-polyisoprene (including synthetic and natural cis 1,4-polyisoprene rubber) and cis 1,4-polybutadiene as well as trans 1,4-polybutadiene 3,4-polyisoprene and high vinyl polybutadiene rubber.

### BRIEF DESCRIPTION OF THE DRAWINGS

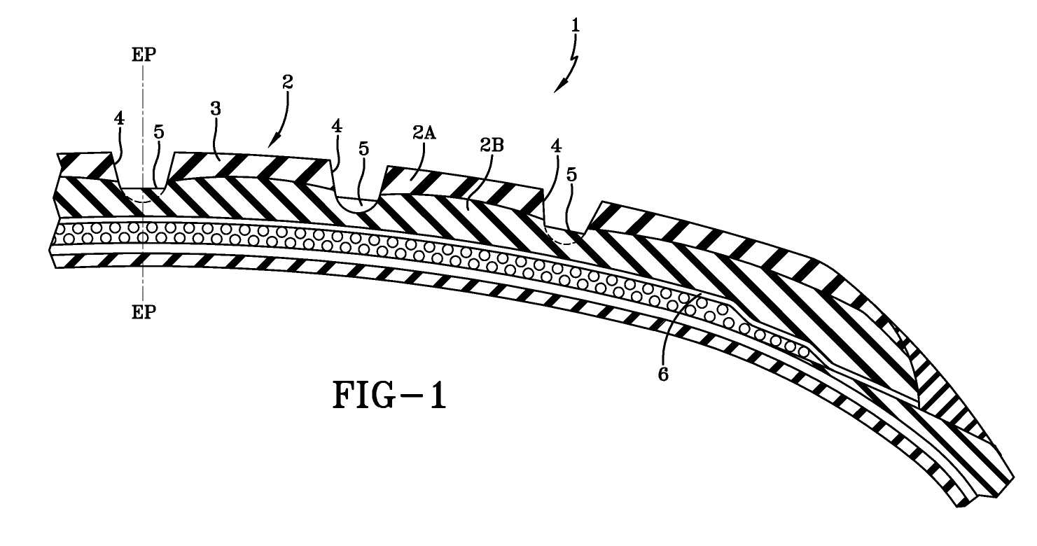

For a further understanding of this invention, drawings are provided in a form of FIG. 1 as a partial cross-sectional view of a tire tread of a cap/base construction

### THE DRAWINGS

FIG. 1 depicts a partial cross-sectional view of a tire tread (1) of a cap/base configuration comprised of a tread cap rubber layer (2) and underlying tread base rubber layer (6) with the tread lugs (3) and grooves (4).

The tread cap rubber layer (2) is composed of two layers, namely an outer tread cap rubber layer (2A) and an underlying inner tread cap rubber layer (2B).

Tread wear indicators (5) are positioned within said tread grooves (4).

The outer tread cap rubber layer (2A) is of a carbon black-rich rubber composition for promoting dry traction for the running surface of the tread (1).

The inner tread cap rubber layer (2B) is of a softer, silica-rich rubber composition for promoting wet traction.

For this drawing, the rubber composition of said tread outer cap rubber layer (2A) has a dynamic storage modulus G′ (at 100° C., 11% strain and 1 Hertz) in a range of from about 4,000 to about 6,000 KPa and the rubber composition of said tread inner cap rubber layer (2) has a dynamic storage modulus G′ (at 100° C., 1% strain and 1 Hertz) in a range of from about 2,500 to about 4,000 KPa, wherein said storage modulus G′ of said rubber composition of said tread cap inner rubber layer (2B) is at least 1,000 KPa less than said storage modulus G′ of said rubber composition of said outer tread cap rubber layer (2A).

For this drawing, the Shore A (100° C.) hardness of the rubber compositions of said tread outer cap rubber layer (2A) and said tread inner cap rubber layer (2B) are in a range of from about 50 to abut 65 and within about 5 Shore A hardness values of each other.

For this drawing, said carbon black-rich rubber composition of said outer tread cap rubber layer (2A) contains about 40 to about 100 phr of rubber reinforcing carbon black and about 5 to about 30 phr of precipitated silica reinforcement together with a silica couple, and

said silica-rich rubber composition of said inner tread cap rubber layer (2B) contains about 50 to about 100 phr precipitated silica together with a silica coupler and 10 to about 45 phr of rubber reinforcing carbon black, wherein the rubber composition of said inner tread cap rubber layer (2B) contains at least 20 phr more of said precipitated silica reinforcement than said rubber composition of said outer tread cap rubber layer (2A).

The circumferential inner tread cap layer (2B) is internally contained within the tread and is therefore exclusive of an exposed surface of the tread until said outer tread cap rubber layer (2A) wears away to geometrically stiffen the tread lugs (3) as they become shorter and expose at least a portion of the inner tread cap rubber layer (2A) during and as a result of use and service of the tire.

From FIG. 1 it can be seen that the inner tread cap rubber layer (2B) extends radially outward into an internal portion of the tread lugs (2) and beyond the height of the tread wear indicators (5).

In such configuration, as the outer tread cap rubber layer (2A) wears away, the inner tread cap rubber layer (2B) before the tread wear indicators (5) are reached and therefore becomes exposed and a portion of the running surface of the tread (1).

As the outer tread cap rubber layer (2A) wears away, the height of the tread lugs (2) becomes geometrically reduced and thereby naturally becomes stiffer in nature and the traction of the tread lugs (2) on dry ground (dry traction of the tread running surface) becomes enhanced.

As the inner tread cap layer (2B) becomes exposed to the running surface of the tire tread (1), the wet traction of the running surface of the tire tread (1) becomes enhanced (partly by the increased precipitated silica reinforcement content of the inner tread cap layer) without significantly reducing the original dry traction (via the geometrically stiffened bite of the tread lugs to the ground) of the running surface (dry traction before the aforesaid wearing away of the outer tread cap rubber layer (2A).

This, then, is considered herein as being a significant aspect of the invention.

In practice, the rubber compositions for the tread rubber layers, including the tread intermediate rubber layer, may be prepared in at least one preparatory (non-productive) mixing step in an internal rubber mixer, often a sequential series of at least two separate and individual preparatory internal rubber mixing steps, or stages, in which the diene-based elastomer is first mixed with the prescribed silica and/or carbon black as the case may be followed by a final mixing step (productive mixing step) in an internal rubber mixer where curatives (sulfur and sulfur vulcanization accelerators) are blended at a lower temperature and for a substantially shorter period of time.

It is conventionally required after each internal rubber mixing step that the rubber mixture is actually removed from the rubber mixer and cooled to a temperature below 40° C., perhaps to a temperature in a range of about 20° C. to about 40° C. and then added back to an internal rubber mixer for the next sequential mixing step, or stage.

Such non-productive mixing, followed by productive mixing is well known by those having skill in such art.

The forming of a tire component is contemplated to be by conventional means such as, for example, by extrusion of rubber composition to provide a shaped, unvulcanized rubber component such as, for example, the a tire tread. Such forming of a tire tread is well known to those having skill in such art.

It is understood that the tire, as a manufactured article, is prepared by shaping and sulfur curing the assembly of its components at an elevated temperature (e.g. 140° C. to 170° C.) and elevated pressure in a suitable mold. Such practice is well known to those having skill in such art.

The following Example is provided to further understand the invention.

### Example I

Rubber compositions are prepared for providing a dual layered tire cap rubber layer as a portion of a tire tread of a cap/base construction comprised of a dual layered outer tread cap rubber layer and an underlying tread base rubber layer of a construction similar to FIG. 1.

As in FIG. 1, the tire cap rubber layer is to be comprised of an outer tread cap rubber layer (2A) and an underlying tread cap inner rubber layer (2B) with the tread cap inner rubber layer (2B) thereby being between the outer tread cap rubber layer (2A) and the tread base rubber layer.

Rubber Sample A is prepared for said outer tread cap rubber layer (2A) and rubber Sample B is prepared for said inner tread cap layer (2B).

Rubber Sample A is comprised of a carbon black-rich rubber composition which contained reinforcing filler comprised of a combination of rubber reinforcing carbon black and precipitated silica in which the majority of the reinforcing filler was rubber reinforcing carbon black.

Rubber Sample B is comprised of a silica-rich rubber which contained reinforcing filler comprised of a combination of rubber reinforcing carbon black and precipitated silica in which the majority of the reinforcing filler was precipitated silica.

A coupling agent used for the rubber compositions.

The rubber compositions are prepared by mixing the ingredients in sequential non-productive (NP) and productive (PR) mixing steps in one or more internal rubber mixers.

The basic recipe for the rubber Samples A and B is presented in the following Table 1 and reported in parts by weight unless otherwise indicated.

TABLE 1

| | Parts |
|---|---|
| Non-Productive Mixing Step (NP), | |
| (mixed to about 170° C.) | |
| S-SBR-A rubber¹ | 0 or 50 |
| S-SBR-B rubber² | 0 or 50 |
| E-SBR-C rubber³ | 0 or 60 |
| E-SBR-D rubber⁴ | 0 or 25 |
| 3,4-Polyisoprene rubber⁵ | 0 or 15 |
| Carbon black (N100 series)^{5A} | 0 or 80 |
| Carbon black (N200 series)^{5B} | 0 or 80 |
| Rubber processing oil and microcrystalline wax | 40 |
| Zinc oxide | 2 |
| Fatty acid⁶ | 2 |
| Antidegradant⁷ | 2.3 |
| Silica⁸ | 25 or 66 |
| Coupling agent⁹ | 2 or 5.5 |
| Productive Mixing Step (PR), | |
| (mixed to about 120° C.) | |
| Sulfur | 0.9 |
| Sulfenamide and thiuram disulfide cure accelerators | 3.5 |

¹Solution polymerization prepared high styrene styrene/butadiene copolymer rubber having a bound styrene content of about 40 percent and a vinyl content of about 14 percent.
²Solution polymerization prepared high styrene, high vinyl styrene/butadiene copolymer rubber having a bound styrene content of about 40 percent and a vinyl content of about 39 percent.
³Emulsion polymerization prepared high styrene styrene/butadiene copolymer rubber having a bound styrene content of about 40 percent and a vinyl content of about 10 percent.
⁴Emulstion polymerization prepared high styrene, high vinyl styrene/butadiene copolymer rubber having a bound styrene content of about 40 percent and a vinyl content of about 39 percent.
⁴Polyisoprene rubber (solution polymerization prepared) comprised of a 3,4-isometric content of about 60 percent and a trans 1,4-isometric content of about 12 percent
^{5A}ASTM designation
^{5B}ASTM designation
⁶Fatty acid comprised (composed) of at least 90 weight percent stearic acid and a minor amount of other fatty acid comprised (composed of) primarily of palmitic and oleic acids.
⁷Antidegradant of the phenylene diamine type
⁸As Zeosil 1165MP ™ from Rhodia
⁹As Si266 ™ from Dow Corning comprised of a bis3(triethoxysilylpropyl) polysulfide with an average of from about 2 to about 2.6 connecting sulfur atoms in its polysulfidic bridge

The following Table 2 illustrates cure behavior and various physical properties (values rounded) of rubber compositions, namely rubber Samples A and B, based upon the recipe of Table 1.

TABLE 2

| | Outer Tread | Inner Tread |
|---|---|---|
| | Cap Layer | Cap Layer |
| | Sample A | Sample B |
| Summary of Elastomers | | |
| and Reinforcement | | |
| S-SBR-A rubber | 50 | 0 |
| S-SBR-B rubber | 50 | 0 |
| E-SBR-C rubber | 0 | 60 |
| E-SBR-D rubber | 0 | 25 |
| 3,4 Polyisoprene rubber | 0 | 15 |
| Carbon black (N100 series), phr | 80 | 0 |
| Carbon black (N200 series), phr | 0 | 36 |
| Silica (phr) | 25 | 66 |
| Coupling agent (phr) | 2 | 5.5 |
| Rheometer, 160° C. | | |
| Maximum torque (dNm) | 19 | 17 |
| Minimum torque (dNm) | 4 | 3 |
| Delta torque (dNm) | 15 | 14 |
| Stress-strain, ATS¹, 16 min, 160° C. | | |
| Tensile strength (MPa) | 15 | 17 |
| Elongation at break (%) | 500 | 550 |
| 300% ring modulus (MPa) | 10 | 9 |
| Rebound | | |
| 23° C. | 12 | 17 |
| 100° C. | 37 | 45 |
| Shore A Hardness | | |
| 23° C. | 79 | 73 |
| 100° C. | 59 | 59 |
| RPA², 100° C., 1 Hertz | | |
| Storage modulus G′ @ 1% strain (KPa) | 4550 | 3000 |

¹Data according to Automated Testing System instrument by the Instron Corporation which incorporates a plurality of (e.g. six) tests in one system. Such instrument may determine physical properties such as ultimate tensile, ultimate elongation, and modulus. Data reported in the Table is generated by running the ring tensile test.
²Data according to Rubber Process Analyzer as RPA 2000 ™ (Alpha Technologies company).

It can be seen from Table 2 that rubber Sample B (rubber composition for the inner tread cap rubber layer) had a 300 percent modulus of 9 MPa which was significantly less as compared to the 300 percent storage modulus of 10 MPa for rubber Sample A (rubber composition for the outer tread cap outer rubber layer).

This is considered herein to be significant in a sense of showing the rubber Sample B to be softer in the sense of 300 percent modulus than rubber Sample B.

It can also be seen from Table 2 that the Storage Modulus G′ for rubber Sample B (rubber composition for the inner tread cap rubber layer) of 3,000 was significantly less than the Storage Modulus G′ of 4,550 for rubber Sample A (rubber composition for the outer tread cap rubber layer).

This is considered herein to be significant in a sense of indicative of significantly better wet traction of the rubber composition of Sample B, as compared to the rubber composition of Sample A, for a tread running surface, particularly in view of the significantly increased silica reinforcement content (66 phr) of rubber Sample B as compared to the precipitated silica reinforcement content (25 phr) rubber Sample A.

This demonstrates a feasibility and benefit of providing a dual layered (two ply) tread cap rubber layer with an outer layer (rubber Sample A) having a tread running surface with promotes dry traction and an underlying secondary rubber layer (rubber Sample B) which can present a tread running surface when the outer tread cap rubber layer wears away which promotes wet traction (as compared to the outer tread cap rubber layer).

Moreover, the Shore A hardness of the rubber Sample B (rubber composition for the tread cap inner rubber layer) is less (softer) at room temperature (about 23° C.) and substantially equal at 100° C. to the Shore A hardness of the rubber Sample A (rubber composition for the tread cap outer rubber layer).

This is considered herein to be significant in the sense of showing that the rubber composition of the tread lugs have a similar Shore A hardness at a running temperature of the tire tread of about 100° C. to promote a geometrically stiffing of the tread lugs even as the underlying tread inner rubber layer may become exposed as the lugs become shorter as tread wears away.

While certain representative embodiments and details have been shown for the purpose of illustrating the subject invention, it will be apparent to those skilled in this art that various changes and modifications can be made therein without departing from the scope of the subject invention.

What is claimed is:

1. A tire having a rubber tread of a cap/base construction comprised of a tread cap rubber layer and an underlying tread base rubber layer;
wherein said tread cap rubber layer is comprised of an outer tread cap rubber layer and an underlying inner tread cap rubber layer;
wherein said tread cap rubber layer is composed of a lug and groove configuration with raised lugs having tread running surfaces and grooves positioned between said lugs, and wherein at least a portion of said grooves extend through said outer tread cap rubber layer and into said tread cap inner rubber layer, exclusive of said underlying tread base rubber layer.

2. The tire of claim 1 wherein the rubber composition of said tread outer cap rubber layer has a dynamic storage modulus G′ (at 100° C., 1% strain and 1 Hertz) in a range of from about 3,000 to about 7,000 KPa and the rubber composition of said tread inner cap rubber layer has a dynamic storage modulus G′ (at 100° C., 1% strain and 1 Hertz) in a range of from about 1,500 to about 4,500 KPa;
wherein said storage modulus G′ of said rubber composition of said tread cap inner rubber layer is at least 1,000 KPa less than said storage modulus G′ of said rubber composition of said outer tread cap rubber layer.

3. The tire of claim 1, wherein said circumferential outer tread cap rubber layer is a sulfur cured rubber composition comprised of, based upon parts by weight per 100 parts by weight rubber (phr):
(A) 100 phr of at least one conjugated diene-based elastomer;
(B) from about 30 to about 110 phr of rubber reinforcing filler comprised of from about 50 to wherein said tread cap rubber layer is composed of a lug and groove configuration with raised lugs having tread running surfaces and grooves positioned between said lugs, and wherein at least a portion of said grooves extend through said outer tread cap rubber layer and into said tread cap inner rubber layer, exclusive of said underlying tread base rubber layer.

4. The tire of claim 1 wherein the rubber composition of said tread outer cap rubber layer has a dynamic storage modulus G′ (at 100° C., 11% strain and 1 Hertz) in a range of from about 3,000 to about 7,000 KPa and the rubber composition of said tread inner cap rubber layer has a dynamic storage modulus G′ (at 100° C., 11% strain and 1 Hertz) in a range of from about 1,500 to about 4,500 KPa;
wherein said storage modulus G′ of said rubber composition of said tread cap inner rubber layer is at least 1,000 KPa less than said storage modulus G′ of said rubber composition of said outer tread cap rubber layer.

5. The tire of claim 1, wherein said circumferential outer tread cap rubber layer is a sulfur cured rubber composition comprised of, based upon parts by weight per 100 parts by weight rubber (phr):
(A) 100 phr of at least one conjugated diene-based elastomer;
(B) from about 30 to about 110 phr of rubber reinforcing filler comprised of:
(1) from about 50 to about 100 phr of rubber reinforcing carbon black,
(2) from about 5 to about 40 phr of precipitated silica; and
(C) silica coupler having a moiety reactive with hydroxyl groups on said silica and another different moiety interactive with said diene-based elastomer(s); and.
said circumferential inner tread cap rubber layer is a rubber composition comprised of, based upon parts by weight per 100 parts by weight rubber (phr):
(D) 100 phr of at least one conjugated diene-based elastomer;
(E) from about 50 to about 110 phr of rubber reinforcing filler comprised of:
(1) from about 35 to about 100 phr of precipitated silica, and
(2) from about 10 to about 30 phr of rubber reinforcing carbon black, and
(F) silica coupler having a moiety reactive with hydroxyl groups on said silica and another different moiety interactive with said diene-based elastomer(s).

6. The tire of claim 1 wherein the Shore A (100° C.) hardness values of the sulfur cured rubber compositions of said tread outer cap rubber layer and said tread inner cap rubber layer are in a range of from about 65 to about 85 and said Shore A hardness of the rubber composition of said tread outer cap rubber layer is at least 5 Shore A hardness units greater than the rubber composition of said tread cap inner rubber layer.

7. The tire of claim 1 wherein, upon wearing away of the outer tread cap rubber layer during the service of the tire, with an associated geometrical stiffening of the tread lugs as they become shorter, to expose at least a portion of the inner tread cap rubber layer as a running surface of the tread, the running surface of the tread thereby presents a combination of enhanced dry and wet traction properties of the tire running surface to the road.

8. The tire of claim 1 wherein said inner tread cap rubber layer extends radially outward into and within at least a portion of at least one of said tread lugs wherein the inner tread cap rubber layer extends radially outward beyond a treadwear indicator positioned within an associated tread groove.

9. The tire of claim 5 wherein the inner tread cap layer within the tread lug extends radially outward beyond the tread wear indicator in a manner that the inner tread cap rubber layer becomes exposed to and thereby a part of the tire tread's running surface as said outer tread cap rubber layer wears away.

10. The tire of claim 1 wherein said coupling agent is be a bis(3-trialkoxysilylalkyl) polysulfide which contains an average of from 2 to 4 connecting sulfur atoms in its polysulfidic bridge.

11. The tire of claim 7 wherein said coupling agent is a bis(3-triethoxysilylpropyl) polysulfide.

12. The tire of claim 1 wherein said coupling agent is an alkoxyorganomercaptosilane.

13. The tire of claim 1 wherein:
(A) wherein the rubber composition of said tread outer cap rubber layer has a dynamic storage modulus G′ (at 100° C., 1% strain and 1 Hertz) in a range of from about 3,000 to about 7,000 KPa and the rubber composition of said tread inner cap rubber layer has a dynamic storage modulus G′ (at 100° C., 1% strain and 1 Hertz) in a range of from about 1,500 to about 4,500 KPa;
wherein said storage modulus G′ of said rubber composition of said tread cap inner rubber layer is at least 1,000 KPa less than said storage modulus G′ of said rubber composition of said outer tread cap rubber layer, and
(B) the said circumferential outer tread cap rubber layer is a rubber composition comprised of, based upon parts by weight per 100 parts by weight rubber (phr):
(1) 100 phr of at least one conjugated diene-based elastomer;
(2) from about 30 to about 110 phr of rubber reinforcing filler comprised of:
(a) from about 50 to about 100 phr of rubber reinforcing carbon black,
(b) from about 5 to about 40 phr of precipitated silica; and
(3) silica coupler having a moiety reactive with hydroxyl groups on said silica and another different moiety interactive with said diene-based elastomer(s); and.
said circumferential inner tread cap rubber layer is a rubber composition comprised of, based upon parts by weight per 100 parts by weight rubber (phr):
(4) 100 phr of at least one conjugated diene-based elastomer;
(5) from about 50 to about 110 phr of rubber reinforcing filler comprised of:
(a) from about 35 to about 100 phr of precipitated silica, and
(b) from about 10 to about 30 phr of rubber reinforcing carbon black, and
(6) silica coupler having a moiety reactive with hydroxyl groups on said silica and another different moiety interactive with said diene-based elastomer(s).
